(19) United States
(12) Patent Application Publication
(10) Pub. No.: US 2011/0193365 A1
(43) Pub. Date: Aug. 11, 2011

(54) Truck bed tray

(76) Inventor: Daniel M. Zernec, Ortonville, MI (US)

(21) Appl. No.: 12/931,006

(22) Filed: Jan. 21, 2011

Related U.S. Application Data
(60) Provisional application No. 61/302,435, filed on Feb. 8, 2010.

(51) Int. Cl. B60R 11/00

(52) U.S. Cl. 296/37.6

(57) ABSTRACT

A tray for a truck bed includes a front wall, a rear wall, a left side wall extending between the front and rear walls, and a right side wall extending between the front and rear walls. An open top of the tray is established by upper surfaces of the walls, and a bottom of the tray is established at least partially by a floor extending between the walls. The tray has a width about less than or equal to one half of an interior width of the truck bed, and a length about equal to an interior length of the truck bed. A truck bed tray system includes a plurality of the trays.

This application claims priority from provisional patent application Ser. No. 61/302,435 filed Feb. 8, 2010.

### TECHNICAL FIELD

This disclosure relates generally to auxiliary carriers for vehicles and, more particularly, to auxiliary carriers for truck beds.

### BACKGROUND

The prior art is crowded with multitudes of truck bed carriers. According to conventional wisdom, truck bed carriers must include special bearings, wheels, tracks, rails, or the like to adapt the carriers to corresponding truck beds. Therefore, prior art carriers are complex and costly apparatuses having many parts and, thus, are largely impractical to manufacture and use. Accordingly, very few truck bed carriers ever achieve real commercial success.

### BRIEF SUMMARY

One exemplary embodiment of a tray for a truck bed includes a from wall, a rear wall, a left side wall extending between the front and rear walls, and a right side wall extending between the front and rear walls. An open top of the tray is established by upper surfaces of the walls, and a bottom of the tray is established at least partially by a floor extending between the walls. The tray has a width about less than or equal to one half of an interior width of the truck bed, and a length about equal to an interior length of the truck bed. In a most preferred embodiment, the tray has the width of about one third of the interior width of a truck bed which often are between 48 and 50 inches between the wheel wells.

In accordance with another exemplary embodiment, there is provided a tray system for a truck bed, including a plurality of trays of N quantity. Each tray includes a front wall, a rear wall, a left side wall extending between the front and rear walls, and a right side wall extending between the front and rear walls. An open top of each try is established by upper surfaces of the walls, and a closed bottom of each tray is established at least partially by a floor extending between the walls. Each tray has a width about equal to 1/N of an interior width of the truck bed, and a length about equal to an interior length of the truck bed.

### BRIEF DESCRIPTION OF THE DRAWINGS

Features and advantages of one or more of the disclosed embodiments of this disclosure will be apparent to those of ordinary skill in the art from the following detailed description of exemplary embodiments and the claims, with reference to the accompanying drawings in which:

FIG. 1A is an end view according to an exemplary embodiment of a truck bed tray system including an exemplary embodiment of trays;

FIG. 1B is a top view according to an exemplary embodiment of a truck bed tray system including an exemplary embodiment of trays;

FIG. 2 is a top view of one of the trays of FIG. 1;

FIG. 3 is a cross-sectional side view of the truck bed tray of FIG. 2 and taken along line 3-3 of FIG. 2;

FIG. 4 is a bottom view of the truck bed tray of FIG. 2; and

FIG. 5 is an enlarged fragmentary view of a portion of FIG. 4, taken from circle 5 of FIG. 4.

### DETAILED DESCRIPTION

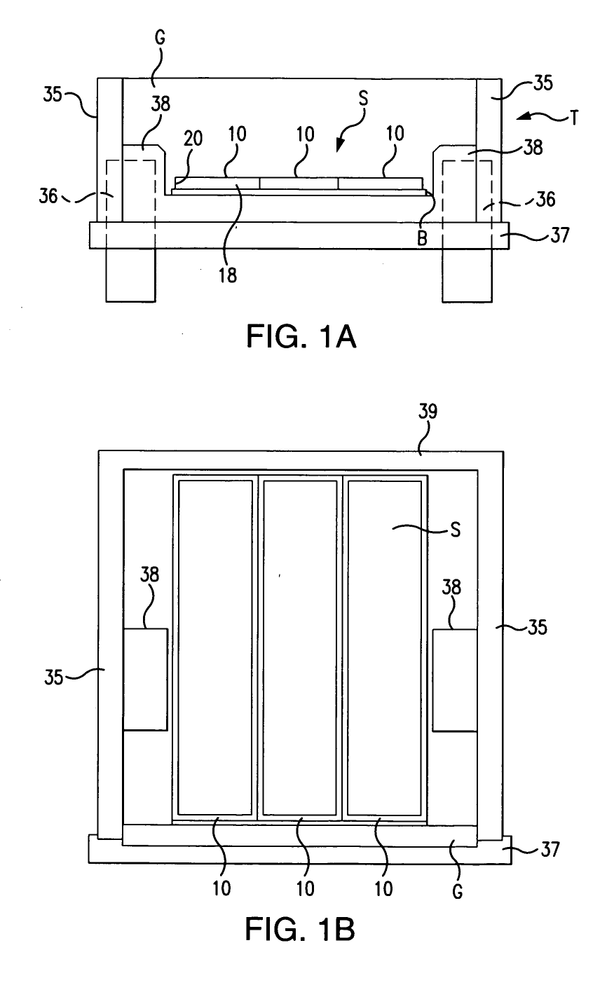

Referring specifically to the drawings, FIGS. 1A and 1B illustrate an exemplary embodiment of a truck bed tray system S, which includes a plurality of trays 10. The trays 10 are disposed in a bed B of a truck T in such a manner that the trays 10 there is little to no sliding of the trays 10 relative to the truck bed B when a tail gate G of the truck T is closed. More specifically, any gaps between the trays 10 and/or between the trays 10 and corresponding surfaces of the truck bed B or any truck bed liner are preferably limited to no greater than about ¼ inch. It will be appreciated, however, that the gaps may be larger depending on the dimension of the truck bed. The bed B may include a bed liner or may be without a liner. As shown in FIGS. 1A and 1B, the truck T consists of side walls 35, tires 36 (shown partially in phantom), back bumper 37 and wheel wells 38. A front wall 39 of the truck bed B is also shown in FIG. 1B.

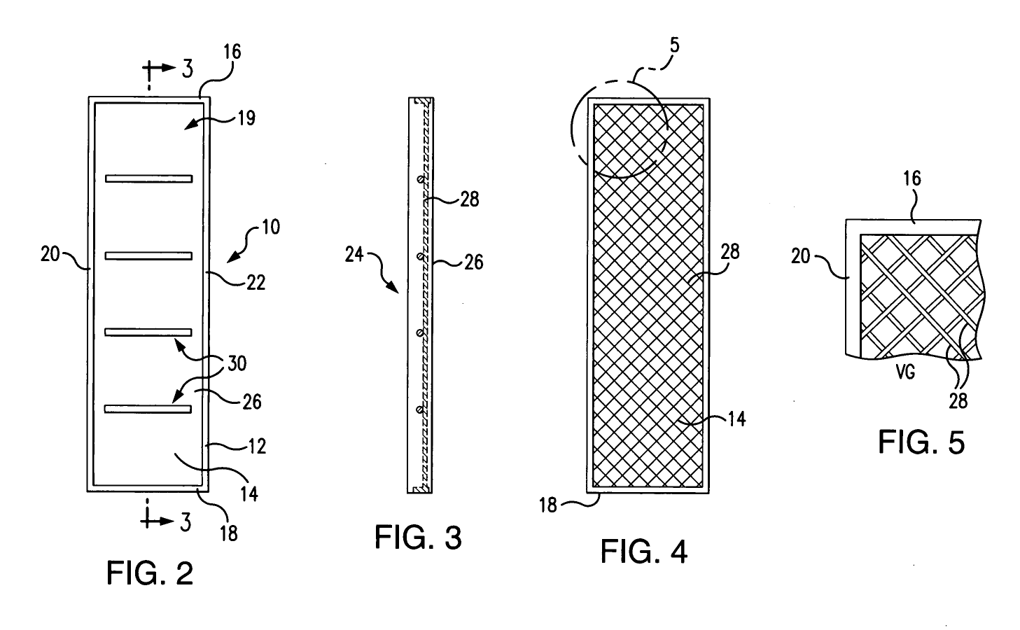

Referring to FIGS. 2-4, each tray 10 generally includes a frame 12 and a floor 14 surrounded and supported by the frame 12. Also, the tray 10 may have a transverse axis X, a longitudinal axis Y, and a vertical axis Z for support.

Referring to FIG. 2, the frame 12 includes a front wall 16, a rear wall 18, and side walls 20, 22 extending between the front and rear walls 16, 18. The front wall 16 may be disposed along the front of the truck bed B (FIG. 1), the rear wall 18 may be disposed along the rear of the truck bed B (FIG. 1), and the side walls 20, 22 include a left side wall 20 and a right side wall 22 that may be disposed along corresponding left and right sides of the truck bed B (FIG. 1) and/or any adjacent trays 10. The walls 16, 18, 20, 22 may be about 1½″ in height and about ¾″ in width, and all corners of the tray 10 may include an about ⅛″ radius. As used herein, the term “about” includes variation for typical manufacturing tolerances for molded components and suitable fit tolerances between components. The length of the walls 16, 18, 20, 22 varies depending on the particular truck bed application and desired quantity of trays. Example lengths include twenty-four, sixteen, twelve, or eight inches for the front and rear walls 16, 18 for two, three, four, or six tray systems. Example lengths for the side walls 20, 22 include 78″ or 96″ for 6½′ or 8′ truck beds.

Referring to FIG. 3, upper surfaces of the walls 16, 18, 20, 22 establish an open top 24 of the tray 10. Similarly, the floor 14 extends across the frame 12, between the walls 16, 18, 20, 22, to at least partially establish a bottom 26 of the tray 10. The bottom 26 also may be established by bottom surfaces of the walls 16, 18, 20, 22, wherein the floor 14 extends between inside surfaces of the walls 16, 18, 20, 22. In one embodiment, the floor 14 is a generally planar panel that may extend from one end to the other and from side to side. In this embodiment, such a panel may be about ¼″ in thickness, and may preferably be solid or imperforate. In any case, the floor 14 may be recessed from the bottom surfaces of the walls 16, 18, 20, 22. For example, the floor 14 may be recessed about ¼″ from bottom surfaces of the walls 16, 18, 20, 22.

Referring to FIGS. 4 and 5, the tray 10 further may include a plurality of spaced apart reinforcement ribs 28 extending between the walls 16, 18, 20, 22 in an angled orientation. The reinforcement ribs 28 may add rigidity to the tray 10 and may at least partly establish a bottom surface of the tray 10. The bottom surface of the tray 10 also may be established by bottom surfaces of the walls 16, 18, 20, 22. In one embodiment, the reinforcement ribs 28 may project from a lower surface of the floor 14 and may extend in an angled orientation across the floor 14. It is believed that the angled orientation of the reinforcement ribs 28 provides a good sliding surface that works well with many different types of truck bed surfaces and, for example, will not hang up or interlock with various features of truck bed surfaces such as channels, holes, pockets, or the like. In one particular embodiment, the reinforcement ribs 28 may extend in a criss-cross pattern across the floor 14. In another embodiment, the reinforcement ribs 28 may extend. It will be appreciated that any other suitable pattern may be employed for the reinforcement ribs.

In any case, the reinforcement ribs 28 may be evenly spaced and may be of such height as to have bottom surfaces that are about coplanar with the bottom surfaces of the walls 16, 18, 20, 22. For example, the reinforcement ribs 28 may be spaced apart about two inches on center. In another example, the height of the reinforcement ribs 28 may be about the same as the distance that the floor 14 is recessed from the bottom surfaces of the walls 16, 18, 20, 22. More specifically, the reinforcement ribs 28 may be about ¼″ in height. Also, the width of the reinforcement ribs 28 may be about the same as the height of the reinforcement ribs 28 and/or the thickness of the floor 14. For example, the reinforcement ribs 28 may be about ¼″ in width.

The tray 10 also may include a plurality of spaced apart retaining ribs 30 laterally between the side walls 20, 22. In one embodiment, the retaining ribs 30 may project from an upper surface of the floor 14 and extend laterally across the floor 14. The retaining ribs 30 may be evenly spaced apart from one another and from the front and rear walls 16, 18 and may be two or more in quantity. In one embodiment, the retaining ribs 30 may be spaced apart the same distance as the width of the tray 10. For example, for a sixteen-inch wide tray, the retaining ribs 30 may be spaced apart sixteen inches and may include at least four ribs. Also, the height of the retaining ribs 30 may be approximately one-half the width of the retaining ribs 30, and the length of the retaining ribs 30 may be such that gaps are provided between laterally outboard ends of the ribs 30 and inside surfaces of the side walls 20, 22. Example dimensions of the retaining ribs 30 include a width of ¼″ and a height of ⅛″. The length of the retaining ribs 30 may vary with the width of the tray 10 itself and, in any event, may be such that 1″ gaps are provided between laterally outboard ends of the ribs 30 and inside surfaces of the side walls 20, 22. For example, the length of the retaining ribs 30 may be about ten to fifteen inches.

The tray 10 further has a relatively low profile compared to prior art carriers. For example, the height of the tray 10 may be about five to twenty percent of the width of the tray 10. More specifically, the tray 10 may be about 1½″ in height. Also, the depth of the interior of the tray 10 as established by a distance between top surfaces of the walls 16, 18, 20, 22 and a top surface of the floor 14, may be about one inch. Accordingly, the tray 10 may be particularly compact so as to maximize cargo carrying capacity of a truck bed.

The tray 10 also has a width about equal to 1/N of an interior width of a corresponding truck bed, for an integer N number of trays 10 to be used in the bed. Therefore, the tray 10 has a width about less than or equal to one half of an interior width of the truck bed, and a length about equal to an interior length of the truck bed. In an exemplary embodiment, the tray 10 has a width of ⅓ of a standard width truck bed between wheel wells. Interior lengths of truck beds vary and, thus, the length of the tray 10 may be, for example, about 6½ feet or eight feet. In contrast, however, an interior width of many truck beds is standard at about four feet. The interior length of a truck bed is typically measured between a front wall of the truck bed and a tail gate of the truck. The interior width of a truck bed is typically measured between wheel wells of the truck bed for a regular style bed and between the side walls of the truck bed for a box style bed. It will be appreciated that while preferred, it is not necessary that each tray have the same width.

So, for example, according to one embodiment using only two of the trays 10 and a standard four feet wide bed, the width of each tray 10 is about twenty-four inches. According to another embodiment, shown in FIG. 1, using three of the trays 10 and the standard four feet wide bed, the width of each tray 10 is about sixteen inches. According to a further embodiment using four of the trays 10 and the standard four feet wide bed, the width of each tray 10 is about twelve inches. According to an additional embodiment using six of the trays 10 and the standard four feet wide bed, the width of each tray 10 is about eight inches. Any suitable quantities and widths of the trays 10 may be used.

The tray 10 need not include or use any wheels, roller or other types of bearings, tracks, and/or rails of any kind. In this manner, the tray 10 may be free floating in the truck bed, need not include attachments to the truck, and are low maintenance products. The tray system uses the truck bed floor and walls to hold them in place. Also, the trays 10 may be interchangeable with one another. Further, the trays 10 may be reversible or turned over to present a shallower tray or a flat surface. The tray 10 may be unitary, and may be a unitary molded article. For example, the tray may be injection molded from a polymeric material. The phrase polymeric material(s) generally includes relatively high-molecular-weight materials of either synthetic or natural origin and may include thermosets, thermoplastics, and/or elastomers. In general, the polymeric material used for the tray may be selected based on its dimensional stability and resistance to abrasion and degradation in hot and cold weather. Example materials for the tray may include high impact plastic. It will be appreciated that any suitable material may be used in the scope of the present invention.

In another embodiment, the tray 10 may be made from a metal material such as for example aluminum. An aluminum tray 10 may be formed for example by stamping a blank and bending or folding the stamped metal to form the walls 16, 18, 20, 22.

It will be appreciated that one or more of the trays 10 may be inverted such that the walls 16, 16, 20 and 22 contact the truck bed. This may be useful when a relatively flatter surface is desirable.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Similarly, when introducing elements of the invention or the example embodiments thereof, the articles “a,” “an,” “the,” and “the” are intended to mean that there are one or more of the elements. Moreover, directional words such as front, rear, top, bottom, upper, lower, radial, circumferential, axial, lateral, longitudinal, vertical, horizontal, transverse, and/or the like are employed by way of description and not limitation. Other terms are to be construed using their broadest reasonable meaning unless they are used in a context that requires a different interpretation.

Finally, the foregoing description is not a definition of the invention, but is a description of one or more examples of exemplary embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and/or the like. Therefore, the invention is not limited to the particular examples of exemplary embodiments disclosed herein, but instead is defined solely by the claims below.

What I claim is:

1. A tray for a truck bed, the tray comprising:
a front wall;
a rear wall;
a left side wall extending between the front and rear walls;
a right side wall extending between the front and rear walls;
an open top established by upper surfaces of the walls;
a bottom established at least partially by a floor extending between the walls;
a width about less than or equal to one half of an interior width of the truck bed; and
a length about equal to an interior length of the truck bed.

2. The tray of claim 1 wherein the width is about equal to 1/N of an interior width of the truck bed for an integer N quantity of trays used in the truck bed.

3. The tray of claim 2 wherein the width is at least one of about twenty-four inches, sixteen inches, twelve inches, or eight inches.

4. The tray of claim 1 wherein the tray is a unitary molded article.

5. The tray of claim 1 wherein the bottom is also established by bottom surfaces of the walls and the floor extends between inside surfaces of the walls and is recessed from the bottom surfaces of the walls.

6. The tray of claim 1, further comprising a plurality of spaced apart retaining ribs extending laterally between the side walls along the bottom.

7. The tray of claim 1, further comprising a plurality of spaced apart reinforcement ribs extending along the bottom between the walls in an angled orientation and at least partly establishing a bottom surface of the tray.

8. The tray of claim 1, wherein the tray is wheel-less, bearing-less, trackless, and rail-less.

9. The tray of claim 1, wherein said floor is a generally planar and imperforate panel, wherein the bottom is closed.

10. A tray system for a truck bed including a plurality of the tray of claim 1.

11. A tray system for a truck bed, the system comprising:
a plurality of trays of N quantity, each of the trays including:
a front wall;
a rear wall;
a left side wall extending between the front and rear walls;
a right side wall extending between the front and rear walls;
an open top established by upper surfaces of the walls;
a closed bottom established at least partially by a floor extending between the walls;
a width about equal to 1/N of an interior width of the truck bed; and
a length about equal to an interior length of the truck bed.

12. The system of claim 11 wherein the quantity N is three and the width is about sixteen inches.

13. The system of claim 11 wherein each of the trays is a unitary molded article.

14. The system of claim 11 wherein the closed bottom is also established by bottom surfaces of the walls and the floor extends between inside surfaces of the walls and is recessed from the bottom surfaces of the walls.

15. The system of claim 11 wherein each of the trays further includes a plurality of spaced apart retaining ribs projecting from an upper surface of the floor and extending laterally across the floor.

16. The system of claim 11 wherein each of the trays further includes a plurality of spaced apart reinforcement ribs projecting from a lower surface of the floor and extending in criss-cross fashion across the floor.

17. A tray system for a truck bed, the system comprising:
a plurality of trays of N quantity, each of the trays having:
a front wall;
a rear wall;
a left side wall extending between the front and rear walls;
a right side wall extending between the front and rear walls;
an open top established by upper surfaces of the walls;
a closed bottom established by bottom surfaces of the walls and by a floor extending between inside surfaces of the walls and recessed from the bottom surfaces of the walls;
a first plurality of spaced apart retaining ribs projecting from an upper surface of the floor and extending laterally across the floor;
a second plurality of spaced apart reinforcement ribs projecting from a lower surface of the floor and extending in criss-cross fashion across the floor;
a width about equal to 1/N of an interior width of the truck bed; and
a length about equal to an interior length of the truck bed.

18. The system of claim 17 wherein the quantity N is three and the width is sixteen inches.

19. The system of claim 17 wherein each of the trays is a unitary molded article.
